(19) United States
(12) Patent Application Publication
(10) Pub. No.: US 2005/0276327 A1
(43) Pub. Date: Dec. 15, 2005

(54) Method and apparatus for predicting motion

(75) Inventors: Nam-suk Lee, Suwon-si (KR); Jang-ook Lee, Suwon-si (KR); Chan-sik Park, Suwon-si (KR); Jae-hun Lee, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., LTD, Suwon-si (KR)

(21) Appl. No.: 11/127,216

(22) Filed: May 12, 2005

(30) Foreign Application Priority Data
Jun. 11, 2004 (KR) 2004-0042917

(51) Int. Cl. H04N 7/12

(52) U.S. Cl. 375/240.16; 375/240.12

(57) ABSTRACT

A method of and an apparatus for predicting a motion. The method of predicting a motion using a hierarchical motion estimation (ME) method includes: compensating for the motion using data stored in an internal memory that has been used in the motion estimation method, without accessing data stored in an external memory. Accordingly, the internal memory for use in the ME is used instead of accessing to the external memory, whereby a burden of a bus is reduced and a processing time for the MC can be reduced.

### CROSS-REFERENCE TO RELATED APPLICATIONS

This application claims the priority of Korean Patent Application No. 2004-42917, filed on Jun. 11, 2004, in the Korean Intellectual Property Office, the disclosure of which is incorporated herein in by reference.

### BACKGROUND OF THE INVENTION

1. Field of the Invention

The present invention relates to an image compressor/decompressor (codec), and more particularly, to a method of and an apparatus for predicting a motion, for use in encoding image data.

2. Description of Related Art

Recently, following H.261, H.263 of International Telecommunications Union—Telecommunication Standardization Sector (ITU-T), and a moving picture experts group-1 (MPEG-1), MPEG-2, MPEG-4 of ISO/IEC, ITU-T H.264 (ISO/IEC MPEG4 AVC) have been established for developing a new moving image standard. This standard, H.264, remarkably improves a compression rate and an image quality by using more various and complicated technologies, compared to the conventional moving image compression standards. Accordingly, H.264 replaces the conventional moving image compression standard and attracts an attention as an application technology for a digital multimedia broadcasting (DMB) and a digital versatile disk (DVD).

FIG. 1 is a block diagram of an H.264 encoder.

Referring to FIG. 1, the H.264 encoder has a prediction unit 110, a transform and quantization unit 120, and an entropy coding unit 130.

The prediction unit 110 performs an inter-prediction and an intra-prediction. The inter-prediction means performing a block prediction of a current picture using a reference picture for which a decoding and a deblocking filtering have already been performed and stored in a buffer. Namely, a prediction is performed using information between pictures. For that purpose, a motion estimation (ME) unit 111 and a motion compensation (MC) unit 112 are provided. The intra-prediction means performing a block prediction using pixel data of a block adjacent to a block to be predicted, within a picture already decoded. For that purpose, an intra-prediction performing unit 116 is provided. The intra-prediction and/or the inter-prediction are performed depending on an attribute of a picture such as an I-picture, a P-picture, and a B-picture. The reference picture and a reconstruction picture are stored in an external memory (SDRAM (synchronous dynamic random access memory)). The ME unit 111 has a separate internal memory 111a inside. The external memory is accessed by a direct memory access (DMA) through a bus but the internal memory needs not to be accessed through a bus, therefore, there is no burden for a bus.

The transform and quantization unit 120 transforms, quantizes, and compresses a predicted sample obtained by performing, at the prediction unit 110, a prediction.

The entropy coding unit 130 performs an encoding for the quantized image data according to a specified method, to output a bit stream conforming to the H.264 standard.

As described above, the H.264/MPEG-4 video codec compresses video data in such a way that a prediction process is performed on sample data by block unit so that a prediction block including the prediction samples is obtained and this prediction block is transformed and quantized.

The ME unit 111 is complicated and requires much calculation in the image codec.

ME is a process for searching for a macro-block most similar to a macro-block inside a current frame from previous frames, using a specified measure function, and obtaining a motion vector representing a difference in a movement position on both macro-blocks. For a representative method for searching for the most similar macro-block, there exists a method for determining a search range, moving a macro-block by one pixel within the range, calculating similarity degree between both macro-blocks using a specified measure method, and searching for the most similar macro-block.

An example of a specified measure method, is a method for obtaining absolute values of a difference between pixel values that correspond to a macro-block within a current frame and a macro-block within a search region, respectively, and if a value obtained by adding the absolute values is minimum regarding the macro-block, determining that macro-block as the most similar macro-block.

More specifically, the similarity degree of a macro-block between a previous frame and a current frame is judged using a matching reference value, i.e., a similarity degree value calculated using pixel values included in macro-blocks of the previous and the current frame. The matching reference value is calculated using a specified measure function, and for the measure function, SAD (sum of absolute difference), SATD (sum of absolute transformed difference), or SSD (sum of squared difference), may be used.

Since a process for calculating the matching reference value is complicated and an amount of calculations is very large, many hardware resources are required in encoding real-time video data. Therefore, a so-called hierarchical ME technology has been developed to reduce an amount of calculations upon estimation of a motion. A hierarchical ME technology means a technology for dividing an original frame into frames of various resolutions and generating a hierarchical motion vector with respect to the frames of respective resolution. Presently, for a widely known method, there exists a multi-resolution multiple candidate search (MRMCS).

The technology is divided into a full search and a local search depending on a degree with which search is performed. The full search is to search all ranges within the search region and the local search is to search part of the search region.

FIG. 2 is a view showing a hierarchical ME method.

Referring to FIG. 2, the hierarchical ME method is shown in which: a current frame and a previous frame to be encoded, are divided into a lower level 230 having an original resolution in itself, a middle level 220 whose resolution is lowered by decimating an image of the lower level 220 into one half, and an upper level 210 whose resolution is lowered by decimating again an image of the middle level 220 into one half. The hierarchical ME method can estimate a motion in high speed by performing ME where various search ranges are adopted using images whose resolutions are different depending on the respective level.

The hierarchical ME method will be described in more detail. In the following description of FIG. 2, it is presumed that the ME is performed by a macro-block unit of a size 16×16 and a search range of the ME is [−16,+16].

In a first operation, the upper level 210 searches for a macro-block most similar to a current macro-block of a size 4×4, one fourth of an original macro-block, from previous frames whose sizes have been reduced into one fourth of original sizes. A search range becomes [−4,+4], one fourth of an original search range. Generally, for a measure function for measuring a matching reference value, i.e., a similarity degree, the above described SAD function is used. The SAD is a value obtained by subtracting a pixel value of a search macro-block from a pixel value of a current macro-block, calculating an absolute value of it, and summing up all the absolute values. The macro-block found by the SAD value and most similar to the current macro-block, and a macro-block secondary most similar to the current macro-block are determined and a motion vector is obtained for the respective case.

In a second operation, the middle level 220 performs a search on a search range [−s,+s] of a previous frame whose size has been reduced to one half of its original size, mainly for three search points in total including search points that corresponds to two motion points found in the first operation, a search point indicated by a predicted motion vector (PMV) obtained by calculating a median of motion vectors of three macro-blocks positioned on the left, the upper side, and the upper right side of a current macro-block in macro-blocks that have already been encoded and where a motion vector is determined, and obtains a macro-block most similar to the current macro-block and a motion vector thereof. Generally, the s value has a value between 2 and 4.

In a third operation, a partial search of [−s,+s] mainly for a search point that corresponds to a macro-block found at the second operation, i.e., a vertex on the upper left side of a macro-block, in a previous frame of the lower level, i.e., a previous frame of an original size, is performed and a macro-block most similar to the current macro-block and a final motion vector thereof are obtained. Accordingly, since a search region is reduced if a hierarchical search method is used instead of the full search, a time and hardware resources consumed for the ME are reduced.

To reduce an amount of calculations for the ME in this manner, a rapid ME method has been developed. Namely, since an internal memory size to be used becomes large if the full search in the ME is realized by a hardware, the hierarchical ME method is used to reduce the internal memory.

However, since a vector value of a direct motion vector for use in the H.264/AVC is not within a determined value range, an external memory should be accessed so as to obtain costs for the direct motion vector in case a prediction mode of an encoder is selected. Therefore, a prediction cost of the direct motion vector for use in the H.264 encoder, is obtained using a motion compensation (MC). At this point, since the external memory should be accessed, there is a problem that a burden is increased for a bus.

### BRIEF SUMMARY

To solve the above and/or other problems, an aspect of the present invention provides a method and an apparatus for predicting a motion without accessing to an external memory in a hierarchical motion estimation method.

According to an aspect of the present invention, there is provided a method for predicting a motion using a hierarchical motion estimation method, including: compensating a motion using data stored in an internal memory that has been used in the motion estimation method, without accessing to data stored in an external memory.

The hierarchical motion estimation method may follow an H.264 standard and the data stored in the external memory may be accessed using a direct memory access method.

According to another aspect of the present invention, there is provided a method for predicting a motion, including: obtaining a direct motion vector; checking whether the direct motion vector is inside an internal memory for use in motion estimation (ME); performing motion compensation (MC) for the direct motion vector using last level data stored in the internal memory without accessing data stored in an external memory, when the direct motion vector is inside the internal memory; and omitting the MC for the direct motion vector when the direct motion vector is not in inside the internal memory.

According to still another aspect of the present invention, there is provided an apparatus for predicting a motion, including: a motion estimation (ME) unit obtaining a direct motion vector using a hierarchical motion estimation (ME) method; and motion compensation (MC) unit checking whether the direct motion vector is inside an internal memory of the ME unit, performing MC for the direct motion vector using data of the last level stored in the internal memory without accessing to data stored in an external memory when the direct motion vector is inside the internal memory, and omitting the MC for the direct motion vector when the direct motion vector does not exist inside the internal memory.

According to further still another aspect of the present invention, there is provided an encoding apparatus, which includes the above-described apparatus for predicting a motion.

According to another embodiment of the present invention, there is provided a method of reducing a processing time for motion compensation (MC), including: performing level-based motion estimation (ME) and accessing stored reference and reconstructed pictures from an external memory to store last level data in the external memory; performing MC for a two-way prediction and for a predicted motion vector (PMV) and obtaining costs thereof; performing MC for a direct mode using an internal memory and obtaining costs thereof; and determining an inter-prediction mode based on the obtained cost values.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a block diagram of an H.264 encoder;

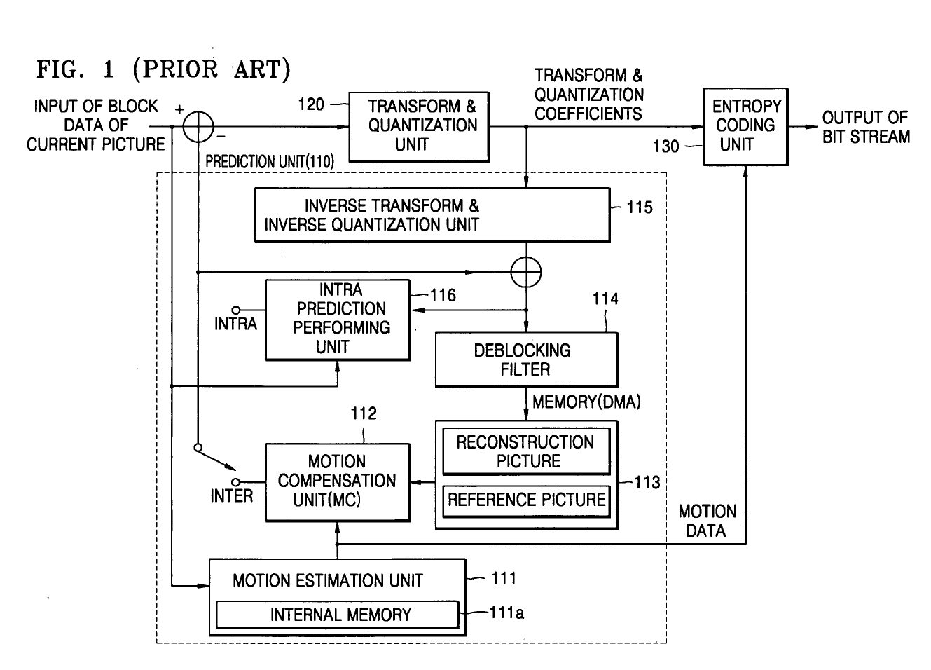

FIG. 2 is a view showing a hierarchical motion estimation method;

FIG. 3 is a flowchart of a method for predicting a motion according to an embodiment of the present invention; and

FIG. 4 is a flowchart of a method for predicting a motion with respect to a direct mode, according to an embodiment of the present invention.

### DETAILED DESCRIPTION OF EMBODIMENT

Reference will now be made in detail to an embodiment of the present invention, examples of which are illustrated in the accompanying drawings, wherein like reference numerals refer to the like elements throughout. The embodiment is described below in order to explain the present invention by referring to the figures.

A motion vector tends to have a value similar to a neighboring motion vector, which is called a correlation of the motion vector. Also, a motion vector of a direct mode tends to have a value similar to a neighboring motion vector because it is obtained using a correlation of a motion vector. Particularly, since a hierarchical motion estimation method uses a correlation of a neighboring motion vector, there is a high probability that a direct motion vector exists inside an internal memory for storing data necessary for ME. If a direct motion vector does not exist inside the internal memory, it will cost much even if the direct motion vector is separately obtained by accessing to an external memory. Therefore, in that case, even if an MC is not made for the direct mode, it may not have a great influence on a performance of a codec.

Therefore, an aspect of the present invention provides a method and an apparatus for estimating a motion, capable of reducing a processing time and reducing a burden of a bus due to access to an external memory, by using an internal memory of an ME unit 111 when obtaining a motion vector for a direct mode using a hierarchical ME technique.

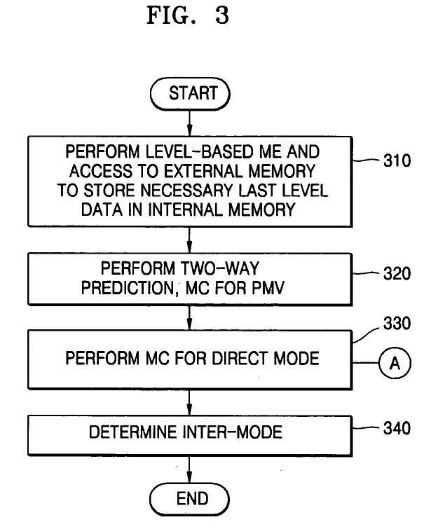

FIG. 3 is a flowchart of a method for predicting a motion according to an embodiment of the present invention.

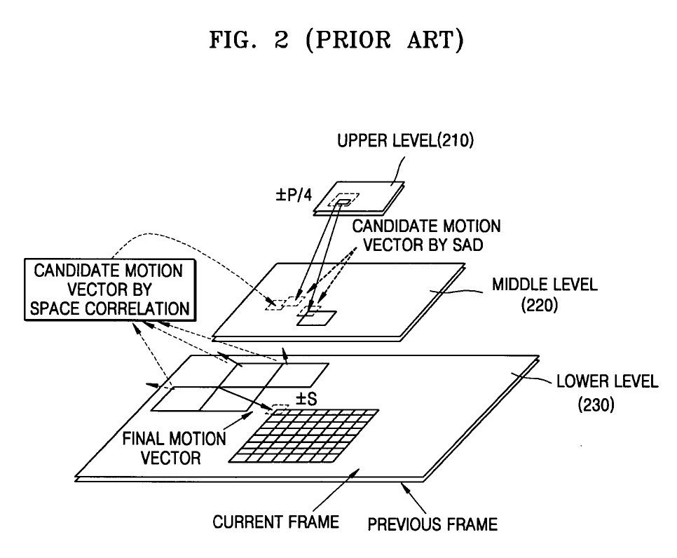

Referring to FIG. 3, a method of predicting a motion according to the present embodiment performs the above-described hierarchical ME to obtain costs, accesses to an external memory where a reference picture and a reconstruction picture are stored, to store data of the above-described last level in an internal memory of a ME unit (operation 310). Namely, since a great amount of calculations and a large size of the internal memory are required for the full search, a hierarchical ME method is used. At this point, only data of a specified region necessary for the last level of the hierarchical ME method, i.e., a lower level such as the lower level 230 shown in FIG. 2, are stored in the internal memory by accessing to the external memory.

Next, MC is performed for a two-way prediction and an PMV (predicted motion vector), and costs thereof are obtained (operation 320). Also, an MC is performed for a direct mode using the internal memory and costs thereof are obtained (operation 330). Lastly, a final prediction mode for an inter-prediction is determined using the cost values obtained in operations 310 through 330 (operation 340).

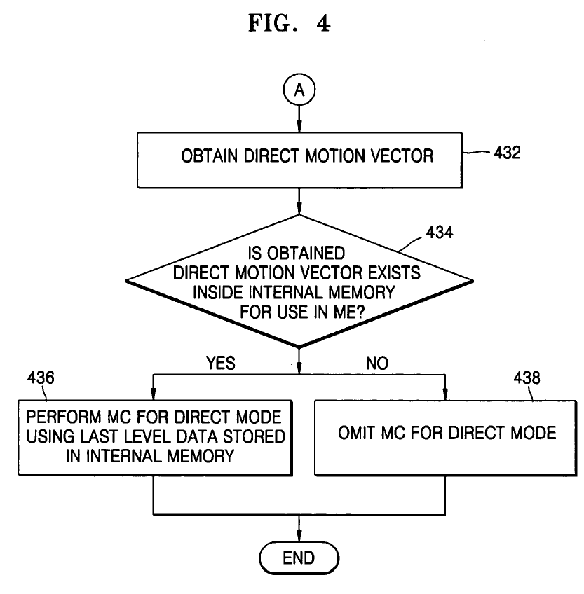

FIG. 4 is a flowchart of a method of predicting a motion with respect to a direct mode, according to the present embodiment.

Referring to FIGS. 3 and 4, a process for performing ME for a direct mode (operation 330) is shown in more detail. Firstly, a direct motion vector is obtained (operation 432), and whether the obtained direct motion vector is inside the internal memory for use in the ME, is checked (operation 434). If the direct motion vector exists inside the internal memory, an MC for the direct mode is performed using data of the last level stored in the internal memory (operation 436). If the direct motion vector does not exist inside the internal memory, the MC for the direct mode is omitted and a procedure is turned over to the next operation (operation 438).

As described above, a motion vector obtained by the hierarchical ME method has a considerable correlation with motion vectors of neighboring macro-block. Therefore, there is a high probability that a final motion vector of a current macro-block is also similar to motion vectors of neighboring macro-block. Therefore, there is a high probability that a newly obtained motion vector is included inside the internal memory where data of the last level is stored. In that case, since an MC is performed using a value stored in the internal memory without accessing the external memory through a bus, it is possible to reduce a processing time for the MC as well as reducing a burden of a bus.

Even if a final motion vector of a newly obtained current macro-block does not exist inside the internal memory, a prediction cost will be increased in view of a correlation of a motion vector. Therefore, it does not have a great influence on an image quality even if this motion vector is not used. Accordingly, in that case, it does not matter much to omit an MC process for the direct mode.

According to the above-described embodiment of the present invention, there is provided a method and an apparatus for compensating for a motion using data stored in the internal memory for use in the ME, without accessing to the external memory in the hierarchical ME method.

Accordingly, the internal memory of the ME is used instead of access to the external memory, whereby a burden of a bus is reduced and a processing time for the MC can be reduced.

Although an embodiment of the present invention have been shown and described, the present invention is not limited to the described embodiment. Instead, it would be appreciated by those skilled in the art that changes may be made to the embodiment without departing from the principles and spirit of the invention, the scope of which is defined by the claims and their equivalents.

1. A method of predicting a motion using a hierarchical motion estimation (ME) method, comprising:
compensating for the motion using data stored in an internal memory that has been used in the ME method, without accessing data stored in an external memory.

2. The method of claim 1, wherein the hierarchical motion estimation method follows an H.264 standard.

3. The method of claim 1, wherein data stored in the external memory is accessed using a direct memory access method.

4. A method for predicting a motion comprising:
obtaining a direct motion vector;
checking whether the direct motion vector is inside an internal memory for use in motion estimation (ME);
performing motion compensation (MC) for the direct motion vector using last level data stored in the internal memory without accessing data stored in an external memory, when the direct motion vector is inside the internal memory; and
omitting the MC for the direct motion vector when the direct motion vector is not in inside the internal memory.

5. The method of claim 4, wherein the hierarchical motion estimation method follows an H.264 standard.

6. The method of claim 1, wherein data stored in the external memory is accessed using a direct memory access method.

7. An apparatus for predicting a motion comprising:
a motion estimation (ME) unit obtaining a direct motion vector using a hierarchical motion estimation (ME) method; and
motion compensation (MC) unit checking whether the direct motion vector is inside an internal memory of the ME unit, performing MC for the direct motion vector using data of the last level stored in the internal memory without accessing to data stored in an external memory when the direct motion vector is inside the internal memory, and omitting the MC for the direct motion vector when the direct motion vector does not exist inside the internal memory.

8. The method of claim 7, wherein the hierarchical motion estimation method follows an H.264 standard.

9. The method of claim 7, wherein data stored in the external memory is accessed using a direct memory access method.

10. An encoding apparatus comprising:
an apparatus for predicting a motion, including:
a motion estimation (ME) unit obtaining a direct motion vector using a hierarchical motion estimation (ME) method; and
motion compensation (MC) unit checking whether the direct motion vector is inside an internal memory of the ME unit, performing MC for the direct motion vector using data of the last level stored in the internal memory without accessing to data stored in an external memory when the direct motion vector is inside the internal memory, and omitting the MC for the direct motion vector when the direct motion vector does not exist inside the internal memory.

11. A method of reducing a processing time for motion compensation (MC), comprising:
performing level-based motion estimation (ME) and accessing stored reference and reconstructed pictures from an external memory to store last level data in the external memory;
performing MC for a two-way prediction and for a predicted motion vector (PMV) and obtaining costs thereof;
performing MC for a direct mode using an internal memory and obtaining costs thereof; and
determining an inter-prediction mode based on the obtained cost values.

12. The method of claim 11, wherein the last level data is data of a specified region necessary for the last level of the hierarchical ME method.

13. The method of claim 11, wherein the performing MC includes:
obtaining a direct motion vector;
determining whether the direct motion vector is inside the internal memory;
performing MC for the direct mode using data of the last level stored in the internal memory when the direct motion vector exists inside the internal memory; and
omitting the MC for the direct mode when the direct motion vector is not in the internal memory.
